(19) United States
(12) Patent Application Publication
(10) Pub. No.: US 2019/0079267 A1
(43) Pub. Date: Mar. 14, 2019

(54) OPTICAL LENS SYSTEM AND IMAGING APPARATUS

(71) Applicant: ACE SOLUTECH CO., LTD, Seongnam-si, Gyeonggi-do (KR)

(72) Inventors: Pil Sun JUNG, Gyeonggi-do (KR); Dong Young KIM, Gyeonggi-do (KR); Chi Ho AN, Gyeonggi-do (KR)

(73) Assignee: ACE SOLUTECH CO., LTD, Seongnam-si, Gyeonggi-do (KR)

(21) Appl. No.: 16/084,614

(22) PCT Filed: Mar. 16, 2017
(86) PCT No.: PCT/KR2017/002831

§ 371 Date: Sep. 13, 2018

(30) Foreign Application Priority Data
Mar. 17, 2016 (KR) 10-2016-0032116

(51) Int. Cl. G02B 9/62; G02B 27/00

(52) U.S. Cl. CPC G02B 9/62; G02B 27/0025

(57) ABSTRACT

Provided are an optical lens system and an imaging apparatus including the optical lens system. The optical lens system includes first to sixth lenses that are sequentially arranged from an object side toward an image plane side and have negative, negative, positive, positive, negative, and positive refractive powers, respectively. The optical lens system may satisfy 0.15<(L1toL2)/OAL<0.4. Here, L1toL2 (unit: mm) refers to the distance between the center of an entrance surface of the first lens and the center of an exit surface of the second lens, and OAL (unit: mm) refers to the distance between the center of the entrance surface of the first lens and the center of an exit surface of the sixth lens.

### CROSS REFERENCE TO RELATED APPLICATIONS

This application is the National Stage of International Application No. PCT/KR2017/002831, having an International Filing Date of 16 Mar. 2017, which designated the United States of America, and which International Application was published under PCT Article 21(2) as WO Publication No. 2017/160091 A1, which claims priority from and the benefit of Korean Patent Application No. 10-2016-0032116, filed on 17 Mar. 2016, the disclosures of which are incorporated herein by reference in their entireties.

### BACKGROUND

### 1. Field

The present disclosure relates to an optical lens system and an imaging apparatus.

### 2. Description of Related Art

Recently, the use and application of cameras including solid-state imaging elements such as complementary metal oxide semiconductor (CMOS) image sensors or charge coupled devices (CCDs) have greatly increased. For example, automobiles require cameras and optical systems for various purposes such as forward monitoring, backward monitoring, lane recognition, or autonomous driving. In addition, various action-cams such as drones or camcorders for leisure or sports activities have been developed. In addition, optical lens systems and solid-state imaging apparatuses are being applied to fingerprint recognition devices. Since fingerprint recognition devices are used in various fields requiring authentication such as entrance control, electronic commerce, financial transactions, personal computer security, or business approval systems, research has been conducted into imaging apparatuses and optical systems for fingerprint recognition devices.

### SUMMARY

The present disclosure provides an optical lens system and an imaging apparatus that are capable of capturing images at a very close distance and at a wide angle (super wide angle).

According to an embodiment, an optical lens system includes a first lens, a second lens, a third lens, a fourth lens, a fifth lens, and a six lens sequentially arranged from an object side toward an image plane side, wherein the first lens has a negative refractive power and an exit surface that is concave toward the image plane side, the second lens has a negative refractive power and an exit surface that is concave toward the image plane side, the third lens has a positive refractive power and an entrance surface that is convex toward the object side, the fourth lens has a positive refractive power and an exit surface that is convex toward the image plane side, the fifth lens has a negative refractive power and an entrance surface that is concave toward the object side, the sixth lens has a positive refractive power and an entrance surface that is convex toward the object side, and the optical lens system may satisfy all the following conditions:

0.15<(L1toL2)/OAL<0.4 Condition (1):

80°<FOV<160° Condition (2):

where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the sixth lens, and FOV refers to a field of view of the optical lens system.

According to the present disclosure, the optical lens system and the imaging apparatus are capable of capturing images at a very close distance with a wide (super wide) field of view.

In addition, according to the present disclosure, the optical lens system and the imaging apparatus may have high reliability and easily guarantee high performance/high resolution.

In addition, according to the present disclosure, various aberrations of the optical lens system and the imaging apparatus may be easily (effectively) corrected and may thus be advantageous for providing high-performance and small/lightweight cameras. In particular, an aspherical glass lens may be applied to at least one of the first to sixth lenses to guarantee high reliability and easily ensure high performance.

### BRIEF DESCRIPTION OF DRAWINGS

FIG. 1 is a cross-sectional view schematically illustrating an arrangement of main elements of an optical lens system according to a first embodiment of the present disclosure.

FIG. 2 is a cross-sectional view schematically illustrating an arrangement of main elements of an optical lens system according to a second embodiment of the present disclosure.

FIG. 3 is a cross-sectional view schematically illustrating an arrangement of main elements of an optical lens system according to a third embodiment of the present disclosure.

FIG. 4 is an aberration diagram illustrating spherical aberration, astigmatic field curvature, and distortion of the optical lens system of the first embodiment.

FIG. 5 is an aberration diagram illustrating spherical aberration, astigmatic field curvature, and distortion of the optical lens system of the second embodiment.

FIG. 6 is an aberration diagram illustrating spherical aberration, astigmatic field curvature, and distortion of the optical lens system of the third embodiment.

FIG. 7 is a schematic perspective view illustrating an imaging apparatus including an optical lens system, according to the present disclosure.

### DETAILED DESCRIPTION

According to an embodiment, an optical lens system may include a first lens, a second lens, a third lens, a fourth lens, a fifth lens, and a six lens sequentially arranged from an object side toward an image plane side, wherein the first lens may have a negative refractive power and an exit surface that is concave toward the image plane side, the second lens may have a negative refractive power and an exit surface that is concave toward the image plane side, the third lens may have a positive refractive power and an entrance surface that is convex toward the object side, the fourth lens may have a positive refractive power and an exit surface that is convex toward the image plane side, the fifth lens may have a negative refractive power and an entrance surface that is concave toward the object side, the sixth lens may have a positive refractive power and an entrance surface that is convex toward the object side, and the optical lens system may satisfy all the following conditions:

0.15<(L1toL2)/OAL<0.4 Condition (1):

80°<FOV<160° Condition (2):

where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the sixth lens, and FOV refers to a field of view of the optical lens system.

The optical lens system may satisfy the following condition:

5<OtoS/IH<20 Condition (3):

where OtoS (unit: mm) refers to a distance from an object to an image plane, and IH (unit: mm) refers to an image height with respect to an effective diameter.

The fourth lens and the fifth lens may be joined together to form a doublet lens and may satisfy the following condition:

0≤TL4L5≤0.03 Condition (4):

where TL4L5 (unit: mm) refers to a distance between a center of the exit surface of the fourth lens and a center of the entrance surface of the fifth lens.

The doublet lens may have a positive refractive power.

At least one of the entrance surface and the exit surface of the sixth lens may be an aspherical surface.

At least one of the first lens or the second lens may be an aspherical lens.

At least one of the first lens or the second lens may have an entrance surface that is convex toward the object side.

The optical lens system may further include an aperture stop between the second and third lenses.

The optical lens system may further include an infrared blocking filter disposed toward the image plane side from the sixth lens.

The first to sixth lenses may be glass lenses.

According to another embodiment, an optical lens system may include a first lens, a second lens, a third lens, a fourth lens, a fifth lens, and a sixth lens that are sequentially arranged from an object side toward an image plane side, wherein the first lens, the second lens, the third lens, the fourth lens, the fifth lens, and the sixth lens may have negative, negative, positive, positive, negative, positive refractive powers, respectively, wherein the first lens may have an exit surface that is concave toward the image plane side, the second lens may have an exit surface that is concave toward the image plane side, the third lens may be a spherical lens having an entrance surface that is convex toward the object side, the fourth lens and the fifth lens may be joined together to form a doublet lens having a positive refractive power, and the sixth lens may have an entrance surface that is convex toward the object side.

The optical lens system may satisfy the following condition:

0.15<(L1toL2)/OAL<0.4 Condition (1):

where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the sixth lens.

The optical lens system may satisfy the following condition:

80°<FOV<160° Condition (2):

where FOV refers to a field of view of the optical lens system.

The optical lens system metal fiber the following condition:

5<OtoS/IH<20 Condition (3):

where OtoS (unit: mm) refers to a distance from an object to an image plane, and IH (unit: mm) refers to an image height with respect to an effective diameter.

The optical lens system may satisfy the following condition:

0≤TL4L5≤0.03 Condition (4):

where TL4L5 (unit: mm) refers to a distance between a center of an exit surface of the fourth lens and a center of an entrance surface of the fifth lens.

At least one of the first lens or the second lens may be an aspherical lens.

At least one of the first lens or the second lens may have an entrance surface that is convex toward the object side.

The first to sixth lenses may be glass lenses.

According to an embodiment, an imaging apparatus may include: the optical lens system of one of the above embodiments; and a solid-state imaging element configured to capture an image formed by the optical lens system.

Hereinafter, optical lens systems and imaging apparatuses will be described according to embodiments of the present disclosure with reference to the accompanying drawings. In the drawings, like reference numerals refer to like (or similar) elements.

In the following description, the term “image plane” refers to a plane on which images are formed by light passing through an optical lens system, and the term “image plane side” may refer to a side at which an imaging element such as an image sensor is located or a direction toward the side. The term “object side” may refer to a side opposite the “image plane side” based on the optical lens system. In addition, a surface of a lens facing the object side may be referred to as an entrance surface, and the other surface of the lens facing the image plane side may be referred to as an exit surface.

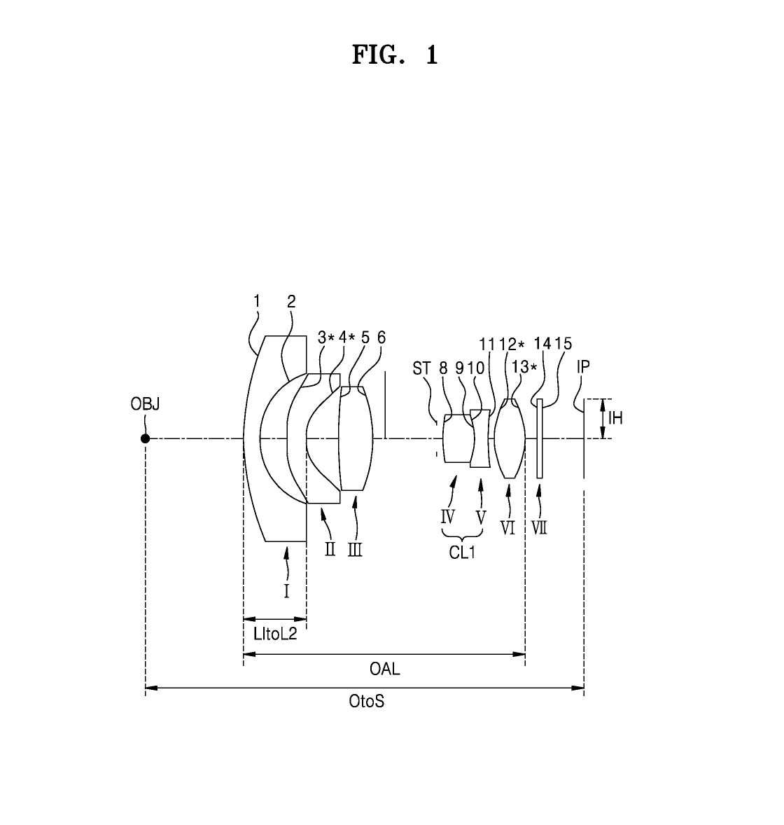

FIGS. 1 to 3 respectively illustrate optical lens systems according to first to third embodiments of the present disclosure.

Referring to FIGS. 1 to 3, each of the optical lens systems of the embodiments of the present disclosure includes a first lens I, a second lens II, a third lens III, a fourth lens IV, a fifth lens V, and a sixth lens VI that are sequentially arranged in a direction from an object OBJ between the object OBJ and an image plane IP on which an image of the object OBJ is formed.

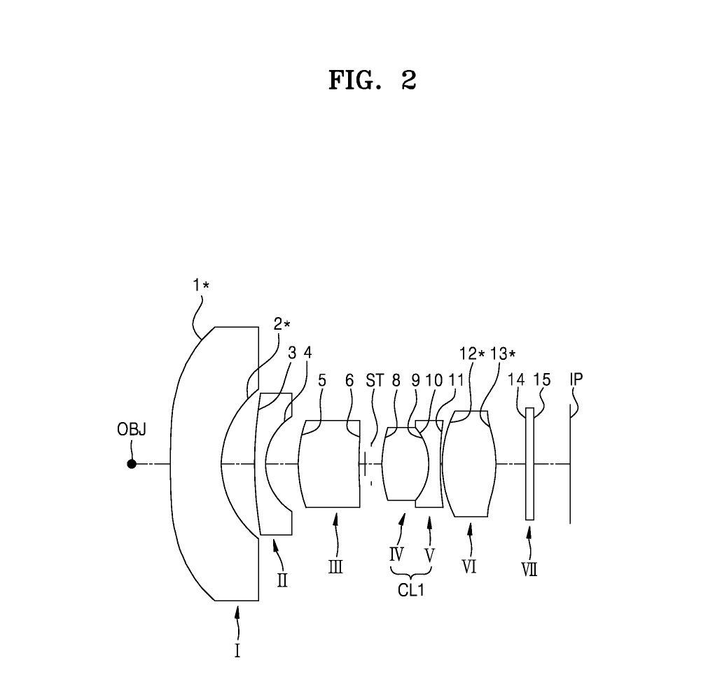

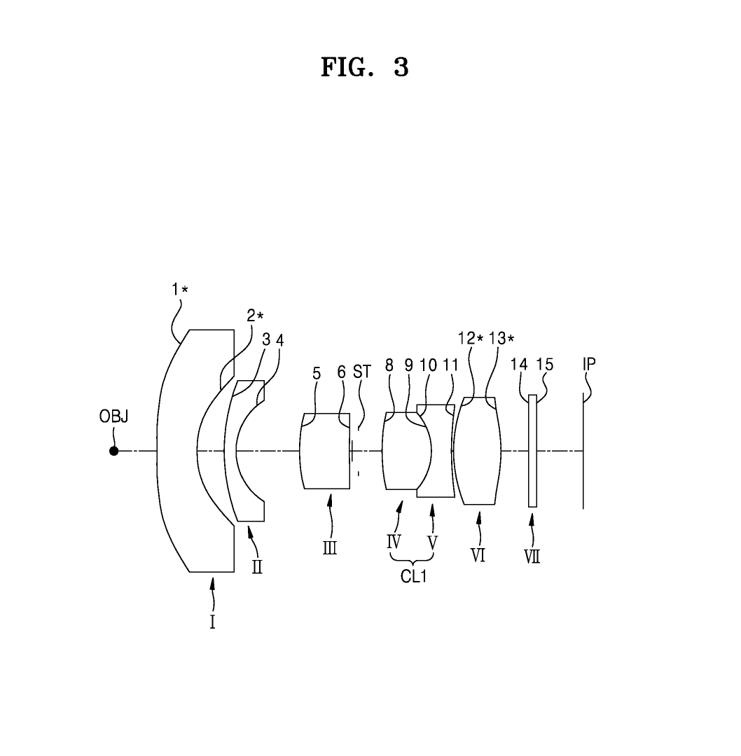

The first lens I may have a negative refractive power. An entrance surface 1 of the first lens I may be convex toward the object OBJ. An exit surface 2 of the first lens I may be concave toward the image plane IP. For example, the first lens I may be a meniscus lens convex toward the object OBJ. The first lens I may be a spherical or aspherical lens. The first lens I shown in FIG. 1 may be a spherical lens. Alternatively, the first lenses I shown in FIGS. 2 and 3 may include at least one aspherical surface. For example, an entrance surface 1* and an exit surface 2* of each of the first lenses I may be aspherical.

The second lens II may have a negative refractive power. An entrance surface 3* of the second lens II may be convex toward the object OBJ, and an exit surface 4* of the second lens II may be concave toward the image plane IP. For example, the second lens II may be a spherical or aspherical lens. The second lens II shown in FIG. 1 may include at least one aspherical surface. For example, an entrance surface 3* and an exit surface 4* of the second lens II may be aspherical. Alternatively, the second lenses II shown in FIGS. 2 and 3 may be spherical lenses. For example, an entrance surface 3 and an exit surface 4 of each of the second lenses II may be spherical.

The second lens II may be a meniscus lens convex toward the object OBJ. At least one of the first and second lenses I and II may be an aspherical lens. In other words, the entrance surface 1* or 3* and the exit surface 2* or 4* of at least one of the first and second lenses I and II may be aspherical.

The third lens III may have a positive refractive power and may have an entrance surface 5 that is convex toward the object OBJ. An exit surface 6 of the third lens III may be convex or concave toward the image plane IP. For example, the third lens III may be a biconvex lens of which both surfaces (i.e., the entrance surface 5 and the exit surface 6) are convex, or may be a meniscus lens convex toward the object OBJ.

The fourth lens IV may have a positive refractive power and may have an exit surface 9 that is convex toward the image plane IP. An entrance surface 8 of the fourth lens IV may be convex toward the object OBJ. For example, both surfaces (i.e., the entrance surface 8 and the exit surface 9) of the fourth lens IV may be convex. That is, the fourth lens IV may be a biconvex lens.

The fifth lens V may have a negative refractive power. The fifth lens V may have an entrance surface 10 that is concave toward the object OBJ. The fifth lens V may have an exit surface 11 that is concave toward the image plane IP. For example, both surfaces (i.e., the entrance surface 10 and the exit surface 11) of the fifth lens V may be concave. That is, the fifth lens V may be a biconcave lens.

The fourth lens IV and the fifth lens V may be joined together to form a doublet lens CL1. In this case, a gap between the fourth lens IV and the fifth lens V may be zero or close to zero. In addition, the exit surface 9 of the fourth lens IV and the entrance surface 10 of the fifth lens V may be substantially the same surface (jointed surface) or may be surfaces very close to each other. The doublet lens CL1 made up of the fourth lens IV and the fifth lens V may have a positive refractive power. In any of the embodiments, the doublet lens CL1 may decrease the aberration and total length of the optical lens system.

The sixth lens VI may have a positive refractive power. The sixth lens VI may have an entrance surface 12* that is convex toward the object OBJ. The sixth lens VI may have an exit surface 13* that is convex toward the image plane IP. For example, both surfaces (i.e., the entrance surface 12* and the exit surface 13*) of the sixth lens VI may be convex. That is, the sixth lens VI may be a biconvex lens. The sixth lens VI may be an aspherical lens. For example, at least one of the entrance surface 12* and the exit surface 13* may be aspherical.

The first to sixth lenses I to VI may be glass or plastic lenses. For example, at least one of the first to sixth lenses I to VI may be a glass lens. At least one of the first to sixth lenses I to VI may be an aspherical lens. For example, the first to sixth lenses I to VI may be aspherical glass lenses. In this case, the first to sixth lenses I to VI may be manufactured using a glass material that can be molded. The use of such aspherical glass lenses makes it possible to guarantee highly reliable characteristics of glass lenses and realize advantages of aspherical surfaces (performance improvements, total length reduction, size reduction, etc.).

For example, at least one of the first to sixth lenses I to VI may be a plastic lens. Plastic lenses may be lightweight and easy to manufacture.

Among the first to sixth lenses I to VI, the first lens I may have the largest outer diameter, and the fourth lens IV may have the smallest outer diameter. Lens outer diameters may increase in the order of the fourth lens IV, the fifth lens V, and the sixth lens VI. The outer diameter of the second lens II may be less than the outer diameter of the first lens I but greater than the outer diameter of the third lens III.

An aperture stop ST and an infrared blocking element VII may be disposed between the object OBJ and the image plane IP. The aperture stop ST may be provided between the third lens III and the fourth lens IV. The infrared blocking element VII may be provided between the sixth lens VI and the image plane IP. The infrared blocking element VII may be an infrared blocking filter. The positions of the aperture stop ST and the infrared blocking element VII may be changed.

Each of the optical lens systems of the embodiments of the present disclosure may satisfy at least one of the following conditions 1 to 4.

0.15<(L1toL2)/OAL<0.4 Condition (1):

L1toL2 (unit: mm) refers to the distance between the center of the entrance surface of the first lens and the center of the exit surface of the second lens. OAL (unit: mm) refers to the distance between the center of the entrance surface of the first lens and the center of the exit surface of the sixth lens.

Condition (1) limits the total thickness of the optical lens system relative to the thicknesses of the first lens I and the second lens II. When the optical lens system of any of the embodiments satisfies Condition (1), the optical lens system is capable of capturing images at a very close distance and has a wide field of view (wide angle of view/super wide angle of view).

Each of the optical lens systems of the embodiments may satisfy Condition (1′) below.

0.2<(L1toL2)/OAL<0.3 Condition (1′):

Each of the optical lens systems of the embodiments may satisfy at least one of Conditions (2) and (3) below.

80°<FOV<160° Condition (2):

where FOV refers to a field of view of the optical lens system.

5<OtoS/IH<20 Condition (3):

where OtoS (unit: mm) refers to the distance from the object OBJ to the image plane IP, and IH (unit: mm) refers to an image height with respect to an effective diameter.

OtoS is measured along an optical axis. In other words, OtoS may be a distance measured along a straight line running from the object OBJ to a center portion of the image plane IP through a center portion of the optical lens system. In addition, IH refers to the diameter of an image formed on the image plane IP, that is, a distance from the center of the image plane IP to an edge of the image.

Each of the optical lens systems of the embodiments may satisfy Condition (2′) and (3′) below.

100°<FOV<120° Condition (2′):

7<OtoS/IH<15 Condition (3′):

Condition (4) is about the distance between the fourth lens IV and the fifth lens V.

0≤TL4L5≤0.03 Condition (4):

TL4L5 (unit: mm) refers to the distance between the fourth lens IV and the fifth lens V. TL4L5 is a distance measured along the optical axis. That is, TL4L5 is a straight distance between a center portion of the exit surface 9 of the fourth lens IV to a center portion of the entrance surface of the fifth lens V.

Condition (4) means that the fourth lens IV and the fifth lens V make up a doublet lens CL1 or are close to each other like a doublet lens CL1. When the optical lens system of any of the embodiments satisfies Condition (4), the aberration and total length of the optical lens system may be reduced.

Expressions in Conditions (1) to (4) have values as shown in Table 1 below in the first to third embodiments. In Table 1, FOV (field of view) is in degrees)(°), and TL4L5 is in millimeters (mm). Table 2 shows values of variables used to obtain data shown in Table 1. In Table 2, values of L1toL2, OAL, OtoS, and IH are in millimeters (mm).

TABLE 1

| | | First | Second | Third |
|---|---|---|---|---|
| | | Embod- | Embod- | Embod- |
| Classification | Inequality | iment | iment | iment |
| Condition (1) | 0.15 < (L1toL2)/OAL < 0.4 | 0.22 | 0.29 | 0.23 |
| Condition (2) | 80 < Fov < 160 | 115.85 | 117.19 | 106.67 |
| Condition (3) | 5 < OtoS/IH < 20 | 10.00 | 8.62 | 10.34 |
| Condition (4) | 0 ≤ TL4L5 ≤ 0.03 | 0.00 | 0.00 | 0.00 |

TABLE 2

| | | Second | |
|---|---|---|---|
| Classification | First Embodiment | Embodiment | Third Embodiment |
| L1toL2 | 4.937 | 4.697 | 3.954 |
| OAL | 22.31 | 16.07 | 17.19 |
| OtoS | 60.00 | 50.00 | 60.00 |
| IH | 6.00 | 5.80 | 5.80 |

Referring to Tables 1 and 2, the optical lens systems of the first to third embodiments satisfy Conditions (1) to (4). In addition, the optical lens systems of the first to third embodiments satisfy all of Conditions (1′) to (3′).

In each of the optical lens systems of the embodiments of the present disclosure having the above-described configuration, at least one of the first to sixth lenses I to VI may be manufactured using a glass material that can be molded. For example, all of the first to sixth lenses I to VI may be manufactured using a glass material that can be molded. In this case, all the first to sixth lenses I to VI may be glass lenses. In this case, the glass lenses guarantee higher reliability than plastic lenses. Furthermore, in the embodiments of the present disclosure, aspherical surfaces may be applied to the glass lenses to obtain various effects by the aspherical surfaces such as total length reduction, compact shaping, aberration correction, or high performance. However, materials of the first to sixth lenses I to VI are not limited to glass. If necessary, at least one of the first to sixth lenses I to VI may be manufactured using a plastic material.

Hereinafter, the first to third embodiments will be described in detail with reference to lens data and the accompanying drawings.

The following Tables 3 to 5 respectively illustrate lens data of the optical lens systems shown in FIGS. 1 to 3, such as radii R of curvature, thicknesses or intervals D, refractive indexes Nd, and Abbe numbers Vd of lenses. Nd refers to the refractive index of a lens measured using the d-line. The d-line refers to a 587-nm light ray. “*” attached to a lens surface number means that the corresponding lens surface is aspherical. R and D are expressed in millimeters (mm).

TABLE 3

| | Surfaces | R | D | Nd | Vd |
|---|---|---|---|---|---|
| I | 1 | 20.00000 | 1.30000 | 1.71300 | 53.83083 |
| | 2 | 5.50000 | 2.13660 | | |
| II | 3* | 79.00000 | 1.50000 | 1.76978 | 49.56915 |
| | 4* | 4.45000 | 2.58490 | | |
| III | 5 | 37.12000 | 2.70000 | 1.78472 | 25.75618 |
| | 6 | −11.25000 | 1.00000 | | |
| | ST | Infinity | 0.50000 | | |
| IV | 8 | 10.00000 | 2.50000 | 1.69680 | 56.17389 |
| | 9 | −5.50000 | 0.00000 | | |
| V | 10 | −5.50000 | 1.10000 | 1.78472 | 25.75618 |
| | 11 | 18.00000 | 0.49250 | | |
| VI | 12* | 5.55000 | 2.40000 | 1.58853 | 61.11657 |
| | 13* | −4.89000 | 1.00000 | | |
| VII | 14 | Infinity | 0.40000 | 1.51680 | 64.16641 |
| | 15 | Infinity | 3.29125 | | |
| | IP | Infinity | 0.00000 | | |

TABLE 4

| | Surfaces | R | D | Nd | Vd |
|---|---|---|---|---|---|
| I | 1* | 78.52735 | 2.50000 | 1.58313 | 59.40501 |
| | 2* | 4.31245 | 1.64705 | | |
| II | 3 | 19.96500 | 0.55000 | 1.77250 | 49.62353 |
| | 4 | 2.74300 | 1.60894 | | |
| III | 5 | 5.96500 | 3.00000 | 1.92286 | 20.88000 |
| | 6 | 18.26700 | 0.30654 | | |
| | ST | Infinity | 0.52208 | | |
| IV | 8 | 5.88300 | 2.30000 | 1.78590 | 43.93370 |
| | 9 | −2.80000 | 0.00000 | | |
| V | 10 | −2.80000 | 0.57000 | 1.84666 | 23.78440 |
| | 11 | 14.28900 | 0.10000 | | |
| VI | 12* | 5.46295 | 2.65041 | 1.80467 | 40.41109 |
| | 13* | −4.85498 | 1.50000 | | |
| VII | 14 | Infinity | 0.40000 | 1.51680 | 64.16641 |
| | 15 | Infinity | 1.79178 | | |
| | IP | Infinity | −0.00772 | | |

TABLE 5

| | Surfaces | R | D | Nd | Vd |
|---|---|---|---|---|---|
| I | 1* | 74.26035 | 2.00000 | 1.51470 | 63.88338 |
| | 2* | 4.70781 | 1.35389 | | |
| II | 3 | 9.27100 | 0.60000 | 1.77250 | 49.62353 |
| | 4 | 2.96000 | 3.16418 | | |
| III | 5 | 7.09500 | 2.50000 | 1.84666 | 23.78440 |
| | 6 | 42.46900 | 0.13668 | | |
| | ST | Infinity | 1.18506 | | |
| IV | 8 | 8.95300 | 2.48000 | 1.83500 | 42.98355 |
| | 9 | −2.81000 | 0.00000 | | |
| V | 10 | −2.81000 | 0.99000 | 1.84666 | 23.78440 |
| | 11 | 15.98300 | 0.10000 | | |
| VI | 12* | 6.48814 | 2.37314 | 1.80467 | 40.41109 |
| | 13* | −7.52088 | 1.38751 | | |
| VII | 14 | Infinity | 0.40000 | 1.51680 | 64.16641 |
| | 15 | Infinity | 2.35701 | | |
| | IP | Infinity | −0.01177 | | |

In addition, the F-number (Fno), focal length (f), and field of view (FOV) of each of the optical lens systems of the first to third embodiments are shown in Table 6 below.

TABLE 6

| | F-number | Focal length (f) | Field of view (FOV) |
|---|---|---|---|
| Classification | (Fno) | [mm] | [°] |
| First Embodiment | 2.45 | 1.94 | 115.85 |
| Second Embodiment | 2.40 | 1.80 | 117.19 |
| Third Embodiment | 2.45 | 2.22 | 106.67 |

In addition, each of the aspherical surfaces of the lenses of the optical lens systems of the first to third embodiments satisfies the following aspherical surface equation:

$$x = \frac{{c}^{′} {y}^{2}}{1 + \sqrt{1 - ( K + 1 ) {c}^{′ 2} {y}^{2}}} + {Ay}^{4} + {By}^{6} + {Cy}^{8} + {Dy}^{10} + {Ey}^{12} \qquad 〈 Aspherical surface equation 〉$$

where x denotes a distance measured from the vertex of a lens in the direction of the optical axis of the lens, y denotes a distance measured from the optical axis in a direction perpendicular to the optical axis, c′ denotes the reciprocal (1/r) of the radius of curvature at the vertex of the lens, K denotes a conic constant, and A, B, C, D, and E denote aspherical surface coefficients.

Tables 7 to 9 below shows aspherical surface coefficients of the aspherical surfaces of the optical lens systems of the first to third embodiments shown in FIGS. 1 to 3.

TABLE 7

| Sur- | | | | | | |
|---|---|---|---|---|---|---|
| faces | K | A | B | C | D | E |
| 3* | −48.60720 | 0.00866 | −0.00059 | 0.00003 | 0.00000 | 0.00000 |
| 4* | −8.33775 | 0.02076 | −0.00147 | 0.00004 | 0.00000 | 0.00000 |
| 12* | −8.34760 | 0.00383 | −0.00035 | 0.00003 | 0.00000 | 0.00000 |
| 13* | −0.56067 | 0.00267 | 0.00007 | −0.00001 | 0.00000 | 0.00000 |

TABLE 8

| Sur- | | | | | | |
|---|---|---|---|---|---|---|
| faces | K | A | B | C | D | E |
| 1* | 117.97688 | 0.00152 | −0.00003 | 0.00000 | 0.00000 | 0.00000 |
| 2* | −3.16840 | 0.00462 | 0.00019 | −0.00002 | 0.00000 | 0.00000 |
| 12* | −9.74743 | 0.00350 | 0.00001 | 0.00000 | 0.00000 | 0.00000 |
| 13* | 0.00000 | 0.00492 | 0.00021 | 0.00003 | 0.00000 | 0.00000 |

TABLE 9

| Sur- | | | | | | |
|---|---|---|---|---|---|---|
| faces | K | A | B | C | D | E |
| 1* | 0.00000 | 0.00230 | −0.00006 | 0.00000 | 0.00000 | 0.00000 |
| 2* | −0.91189 | 0.00253 | 0.00035 | −0.00004 | 0.00000 | 0.00000 |
| 12* | −6.14603 | 0.00141 | 0.00005 | 0.00000 | 0.00000 | 0.00000 |
| 13* | 0.16569 | 0.00294 | 0.00008 | 0.00000 | 0.00000 | 0.00000 |

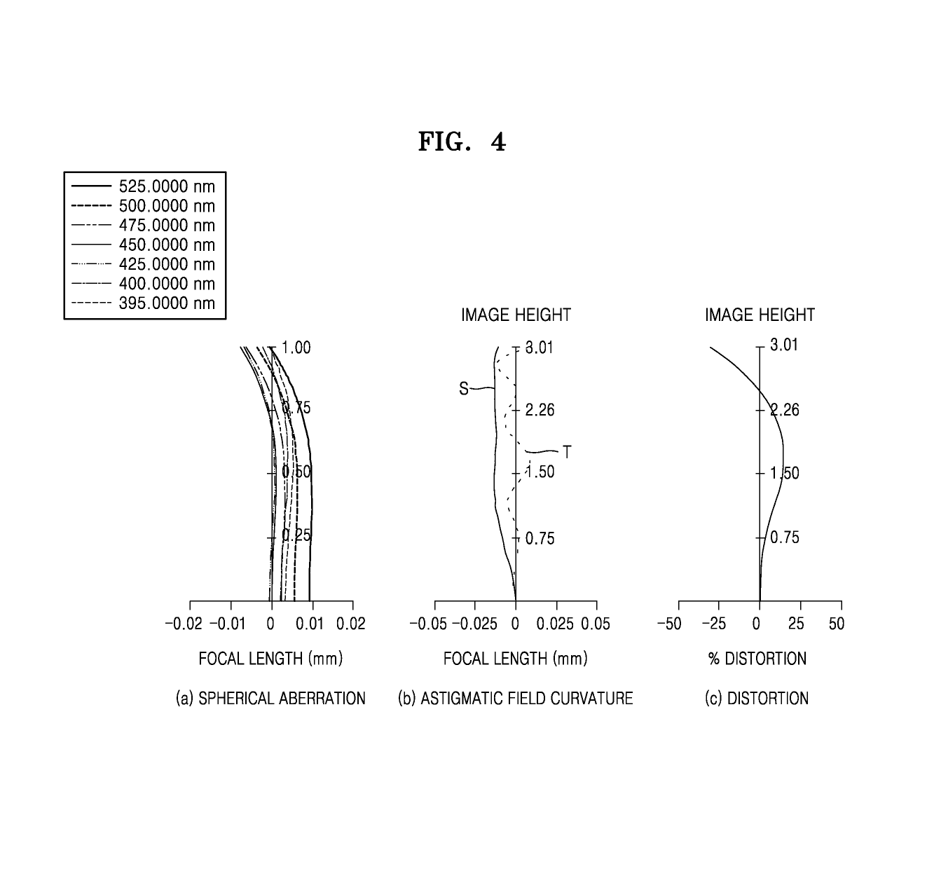

FIG. 4 is an aberration diagram illustrating longitudinal spherical aberration, astigmatic field curvature, and distortion of the optical lens system of the first embodiment (FIG. 1) having the data shown in Table 3.

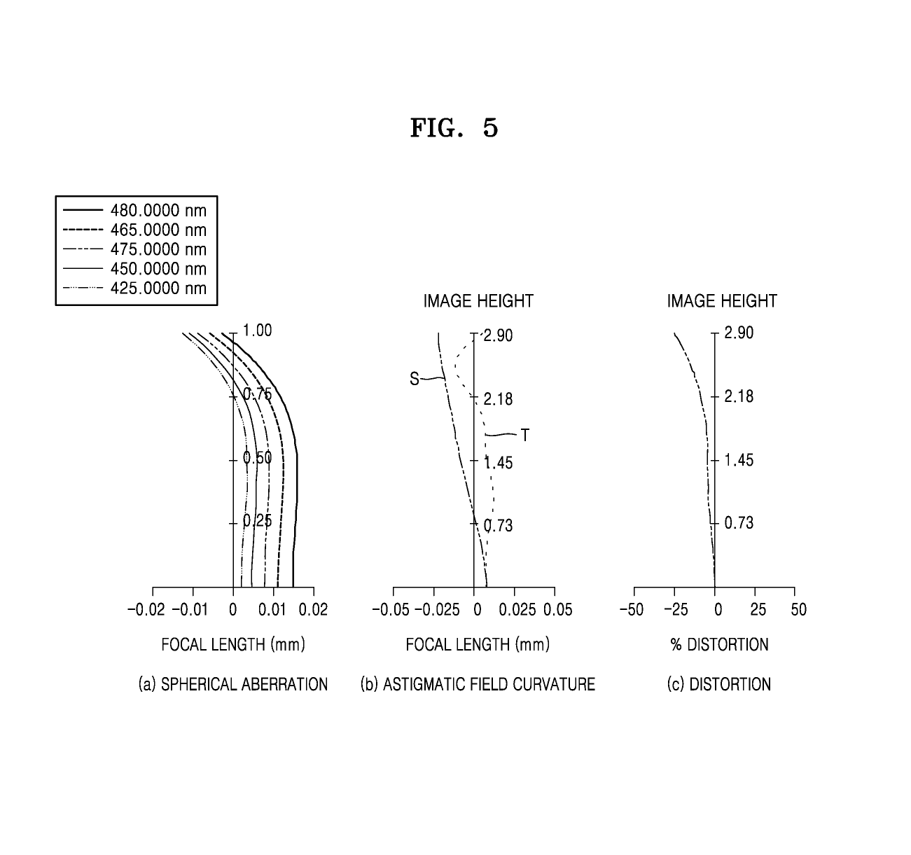

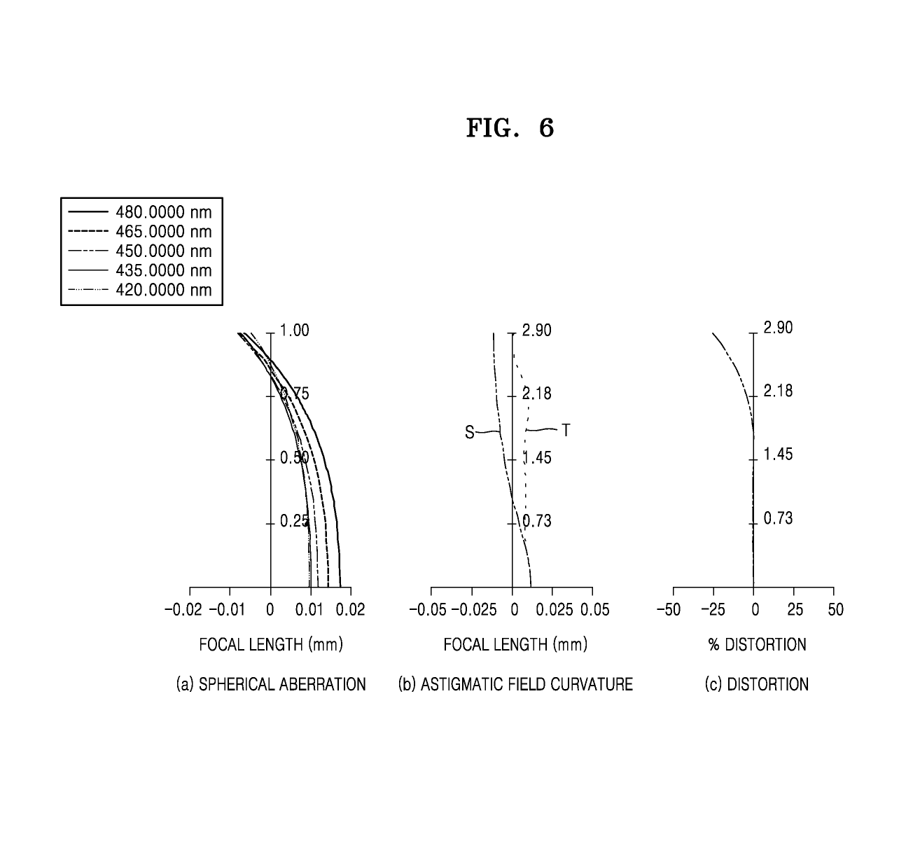

In FIG. 4, the graph (a) shows the spherical aberration of the optical lens system with respect to light having various wavelengths, and the graph (b) shows the astigmatic field curvature of the optical lens system including a tangential field curvature T and a sagittal field curvature S. Data of the graph (a) were obtained using light having wavelengths of 525 nm, 500 nm, 475 nm, 450 nm, 425 nm, 400 nm, and 395 nm. Data of the graphs (b) and (c) were obtained using light having a wavelength of 450 nm. Graphs of FIGS. 5 and 6 were obtained in the same manner.

FIG. 5 is an aberration diagram in which (a), (b), and (c) respectively indicate longitudinal spherical aberration, astigmatic field curvature, and distortion of the optical lens system of the second embodiment (FIG. 2) having the data shown in Table 4.

FIG. 6 is an aberration diagram in which (a), (b), and (c) respectively indicate longitudinal spherical aberration, astigmatic field curvature, and distortion of the optical lens system of the third embodiment (FIG. 3) having the data shown in Table 5.

As described above, each of the optical lens systems of the embodiments includes the first to sixth lenses I to VI which have negative, negative, positive, positive, negative, and positive refractive powers and are sequentially arranged in a direction from the object OBJ between the object OBJ and the image plane IP on which an image of the object OBJ is formed, and each of the optical lens systems may satisfy at least one of Conditions (1) to (4). The optical lens systems may be capable of capturing images at a very close distance and may have wide fields of view (wide angle of view/super wide angle of view), and various aberrations thereof may effectively be corrected. In addition, the first to sixth lenses I to VI may be manufactured using glass, and at least one of both surfaces (entrance surface and exit surface) of each of the first to sixth lenses I to VI may be formed as an aspherical surface, to improve reliability and performance of the optical lens systems.

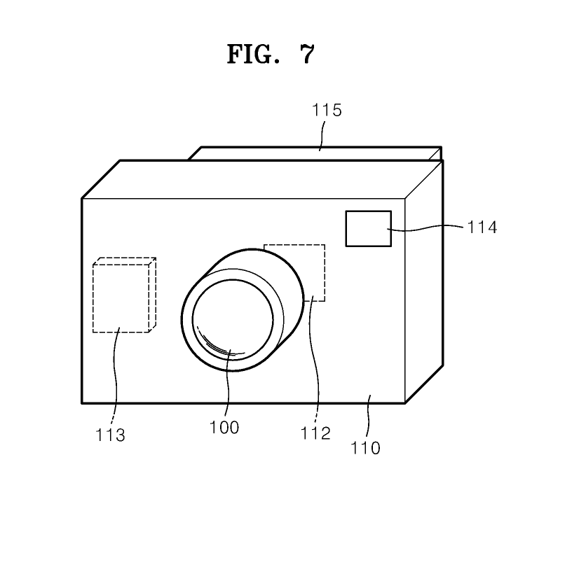

FIG. 7 is a view illustrating an imaging apparatus 110 including an optical lens system 100 according to an embodiment of the present disclosure. The optical lens system 100 may include the optical lens systems of the previous embodiments. In addition, the imaging apparatus 110 includes a solid-state imaging element 112 receiving light focused by the optical lens system 100. A light-receiving surface of the solid-state imaging element 112 may correspond to the image plane IP in the previous embodiments. The imaging apparatus 110 may include: a recording medium 113 configured to record information corresponding to an object image photo-electrically converted by the solid-state imaging element 112; and a viewfinder 114 used to observe an object to be photographed. In addition, a display unit 115 may be provided to display object images. Here, the viewfinder 114 and the display unit 115 are separately provided. However, only the display unit 115 may be provided without the viewfinder 114. Although FIG. 7 illustrates a general camera shape, this is for ease of description and not for purposes of limitation. The imaging apparatus 110 may have various shapes according to application fields.

The imaging apparatus illustrated in FIG. 7 is merely a general example. That is, application to various optical apparatuses is possible. For example, the optical lens systems of the embodiments may be applied to fingerprint recognition apparatuses or vein recognition apparatuses. In general, a fingerprint recognition apparatus takes an image of a user's finger in a state in which the user's finger put close to the surface of a lens, and thus the optical lens systems of the embodiments capable of capturing images at a very close distance and having a wide field of view may be preferably used in such fingerprint recognition apparatuses.

In addition, the optical lens systems of the embodiments may be used as lens systems of automotive cameras. For example, the optical lens systems of the embodiments of the present disclosure may be applied to various automotive apparatuses such as black boxes, around view monitoring (AVM) systems, or rear cameras. In addition, the optical lens systems of the embodiments may be applied to various action-cams such as drones or camcorders for leisure or sports activities. In addition, the optical lens systems of the embodiments may be applied to various surveillance cameras. In addition, the optical lens systems of the embodiments of the present disclosure may be used in various other fields as well as in the above-mentioned fields.

In the above description, many features have been stated in detail. However, these features are not for limiting the scope of the present disclosure but should be construed as preferable embodiments. For example, it will be apparent to those of ordinary skill in the art that although the shapes of the lenses of the optical lens systems of the embodiments of the present disclosure are modified to some degree, the above-described effects may be obtained when the optical lens systems satisfy at least one of Conditions (1) to (4). In addition, although the optical lens systems do not satisfy some of Conditions (1) to (4), when the distribution of the refractive powers of the lenses, the structural conditions of the lenses, and other conditions are satisfied, the above-described effects may be obtained. In addition, a blocking film may be used as the infrared blocking element VII instead of using a filter. Other various embodiments may be provided. Thus, the scope and spirit of the present disclosure are defined not by the descriptions of the embodiments but by the appended claims.

What is claimed is:

1. An optical lens system comprising a first lens, a second lens, a third lens, a fourth lens, a fifth lens, and a sixth lens that are sequentially arranged from an object side toward an image plane side,
wherein the first lens has a negative refractive power and has an exit surface that is concave toward the image plane side,
wherein the sixth lens has a positive refractive power and has an entrance surface that is convex toward the object side, and the optical lens system satisfies all the following conditions:
0.15<(L1toL2)/OAL<0.4 Condition (1):
80°<FOV<160° Condition (2):
where L1toL2 (unit: mm) refers to a distance between a center of an entrance surface of the first lens and a center of an exit surface of the second lens, OAL (unit: mm) refers to a distance between the center of the entrance surface of the first lens and a center of an exit surface of the sixth lens, and FOV refers to a field of view of the optical lens system.

2. The optical lens system of claim 1, wherein the optical lens system further satisfies the following condition:
5<OtoS/IH<20 Condition (3):
where OtoS (unit: mm) refers to a distance from an object to an image plane, and IH (unit: mm) refers to an image height with respect to an effective diameter.

3. The optical lens system of claim 1, wherein the fourth lens and the fifth lens are joined together to form a doublet lens, and the optical lens system satisfies the following condition:
0≤TL4L5≤0.03 Condition (4):
where TL4L5 (unit: mm) refers to a distance between a center of an exit surface of the fourth lens and a center of an entrance surface of the fifth lens.

4. The optical lens system of claim 3, wherein the doublet lens has a positive refractive power.

5. The optical lens system of claim 1, wherein at least one of the entrance surface and the exit surface of the sixth lens is an aspherical surface.

6. The optical lens system of claim 1, wherein at least one of the first lens or the second lens is an aspherical lens.

7. The optical lens system of claim 1, wherein at least one of the first lens or the second lens has an entrance surface that is convex toward the object side.

8. The optical lens system of claim 1, further comprising an aperture stop between the third lens and the fourth lens.

9. The optical lens system of claim 1, further comprising an infrared blocking filter disposed toward the image plane side from the sixth lens.

10. The optical lens system of claim 1, wherein the first to sixth lenses are glass lenses.

11. An optical lens system comprising a first lens, a second lens, a third lens, a fourth lens, a fifth lens, and a sixth lens that are sequentially arranged from an object side toward an image plane side,
wherein the first lens, the second lens, the third lens, the fourth lens, the fifth lens, and the sixth lens have negative, negative, positive, positive, negative, and positive refractive powers, respectively,
wherein the first lens has an exit surface that is concave toward the image plane side, the second lens has an exit surface that is concave toward the image plane side,
the third lens is a spherical lens having an entrance surface that is convex toward the object side,
the fourth lens and the fifth lens are joined together to form a doublet lens having a positive refractive power, and
the sixth lens is an aspherical lens having an entrance surface that is convex toward the object side.

12. The optical lens system of claim 11, wherein the optical lens system satisfies the following condition:
0.15<(L1toL2)/OAL<0.4 Condition (1):
where L1toL2 (unit: mm) refers to a distance between a center of an entrance surface of the first lens and a center of the exit surface of the second lens, OAL (unit: mm) refers to a distance between the center of the entrance surface of the first lens and a center of an exit surface of the sixth lens.

13. The optical lens system of claim 11, wherein the optical lens system satisfies the following condition:
80°<FOV<160° Condition (2):
where FOV refers to a field of view of the optical lens system.

14. The optical lens system of claim 11, wherein the optical lens system satisfies the following condition:
5<OtoS/IH<20 Condition (3):
where OtoS (unit: mm) refers to a distance from an object to an image plane, and IH (unit: mm) refers to an image height with respect to an effective diameter.

15. The optical lens system of claim 11, wherein the optical lens system satisfies the following condition:
0≤TL4L5≤0.03 Condition (4):
where TL4L5 (unit: mm) refers to a distance between a center of an exit surface of the fourth lens and a center of an entrance surface of the fifth lens.

16. The optical lens system of claim 11, wherein at least one of the first lens or the second lens is an aspherical lens.

17. The optical lens system of claim 11, wherein at least one of the first lens or the second lens has an entrance surface that is convex toward the object side.

18. The optical lens system of claim 11, wherein the first to sixth lenses are glass lenses.

19. The optical lens system of claim 1, wherein the second lens has a negative refractive power,
the third lens has a positive refractive power,
the fourth lens has a positive refractive power, and
the fifth lens has a negative refractive power.

20. An imaging apparatus comprising:
the optical lens system of claim 1; and
a solid-state imaging element configured to capture an image formed by the optical lens system.
